(19) United States
(12) Patent Application Publication
(10) Pub. No.: US 2009/0040053 A1
(43) Pub. Date: Feb. 12, 2009

(54) Remote Locator System

(76) Inventor: Robert McCall White, Danville, CA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 12/248,713

(22) Filed: Oct. 9, 2008

Related U.S. Application Data
(63) Continuation-in-part of application No. 11/123,908, filed on May 6, 2005, now Pat. No. 7,446,664.
(60) Provisional application No. 60/569,520, filed on May 6, 2004.

(51) Int. Cl. G08B 23/00

(52) U.S. Cl. 340/573.4

(57) ABSTRACT

A remote locator system for tracking as lost child wherein a first remote locator unit is inconspicuously concealed on or located proximal to a small child. A second remote locator unit may be carried by a parent or caregiver. The remote locator system may include a receiver, transmitter, and/or a proximity device to enable at least one remote locator unit to monitor and or locate a corresponding remote locator unit.

This is a continuation-in-part of Ser. No. 11/123,908, filed May 6, 2005, which in turn claims the benefit of U.S. Provisional Patent Application No. 60/569,520, filed on May 6, 2004, the disclosures of which are hereby incorporated by reference as if set forth fully herein.

### BACKGROUND OF THE INVENTION

1. Field of the Invention

The present invention is directed to a system for use in locating wandering, missing, lost or abducted individuals and/or misplaced or stolen objects. In particular, the present invention may be useful in field of electronic child protection.

2. Description of the Related Technology

The risk of abduction is one of the greatest causes of concern to parents and child care providers. In the United States thousands of children are abducted or lost at public venues each year. Many children are lost or abducted while returning from school, playing at a friend's house, engaging in extended outdoor activities, such as hiking or camping, or visiting shopping stores and malls.

Increasingly, care givers are relying on new technology, such as portable monitor and alarm systems, to protect their children from abduction, injury and harm. Portable child monitoring systems of the prior art, however, are typically obtrusive devices that are poorly concealed and easily removed from a child. Additionally, they tend to be complicated devices that are difficult to operate and consequently, may pose a serious hindrance in emergency situations. Furthermore, these devices generally use antiquated signal encryption technology and inefficient proximity sensors.

### SUMMARY OF THE INVENTION

In accordance with one aspect of the invention, the remote locator system comprises a first unit and a second unit. The first unit comprises a first receiver for receiving a signal from a first transmitter; a first alarm for producing an alert; a first microcontroller for enabling communication with a second unit on a select frequency, wherein said first microcontroller is operatively associated with said first receiver to receive a signal; a first voltage regulator for indicating a low power supply; and a first power supply; wherein said first unit is removably attached to or integral with an article worn by or an object located proximal to an individual. The second unit comprises said first transmitter for transmitting a signal to said first receiver; a button for activating said alarm; a second microcontroller for randomly selecting said frequency to enable secure communication with said first unit, wherein said second microcontroller is operatively associated with said first transmitter to produce a signal; a second alarm for producing an alert; a second voltage regulator for indicating a low power supply; and a second power supply.

In a second aspect of the invention, the remote locator system comprises a first unit and a second unit. The first unit consists essentially of a first receiver for receiving a signal from a first transmitter; a second transmitter for sending a signal to a second receiver; a first antenna; an alarm for producing an alert; a first microcontroller for enabling communication with a second unit on a select frequency; a first proximity device that receives a signal from a second unit to determine when the first unit has exceeded a predetermined distance from a second unit; a first voltage regulator for indicating a low power supply; a first power supply; and a first on/off switch, wherein said first unit is removably attached to or integral with an article worn by or an object located proximal to an individual. The second unit consisting essentially of said first transmitter for transmitting a signal to said first receiver; said second receiver for receiving a signal from said second transmitter; a second antenna; a second alarm for producing an alert; a button for activating said audio generator; a second microcontroller for randomly selecting said frequency to enable secure communication with said first unit; a second proximity device that receives a signal from said first unit to indicate when the first unit has exceeded a predetermined distance from the second unit; a second voltage regulator for indicating a low power supply; a second power supply; and a first on/off switch.

In a third aspect, the invention is directed to a method for using a remote locator system. The method comprises the steps of providing a remote locator system comprising a first unit and a second unit. The first unit comprises a first receiver; a first alarm; a first microcontroller; a first voltage regulator; and a first power supply. The second unit comprises a first transmitter; a button; a second microcontroller; a second alarm; a second voltage regulator; and a second power supply. The method further includes the steps of arming said remote locator units and sending a signal from said transmitter of said second unit to said receiver of said first unit to activate said first alarm.

### BRIEF DESCRIPTION OF THE DRAWINGS

FIG. 1 is an exemplary embodiment of the remote locator system of the present invention.

FIG. 2 is a perspective view of the first remote locator unit of FIG. 1.

FIG. 3 is a perspective view of another exemplary embodiment of the first remote locator unit.

FIG. 4 is a rear view of the remote locator unit of FIG. 3 incorporated in a shoe.

FIG. 5 is a side view of FIG. 4.

FIG. 6 shows how the remote locator unit of FIG. 3 may be inserted in a shoe.

FIG. 7(a) is one embodiment of a second remote locator unit of the present invention.

FIG. 7(b) is a perspective view of the second remote locator unit of FIG. 7(a).

FIG. 8 is a block diagram of an embodiment of the first and second remote locator units.

FIG. 9 is a block diagram of another embodiment of the first and second remote locator units.

FIG. 10(a) is a circuit diagram of an exemplary embodiment of a first remote locator unit.

FIG. 10(b) is a circuit diagram of an exemplary embodiment of a second remote locator unit.

### DETAILED DESCRIPTION OF THE PREFERRED EMBODIMENT(S)

For illustrative purposes, the principles of the present invention are described by referencing various exemplary embodiments. Although certain embodiments of the invention are specifically described herein, one of ordinary skill in the art will readily recognize that the same principles are equally applicable to, and can be employed in other systems and methods. Before explaining the disclosed embodiments of the present invention in detail, it is to be understood that the invention is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Thus, for example, reference to “a proximity device” may include a plurality of proximity devices and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

The present invention is directed to a remote locator system that may be particularly effective for locating lost or wandering children. The technological basis of the invention is predicated upon the importance of developing a concealed, user friendly and highly effective remote locator system and method for use. This may be accomplished by: concealing a remote locator unit in close proximity to a child; securing the remote locator unit in close proximity to a child; and/or providing an effective proximity detector and/or tracking device. It is envisioned that the remote locator system of the present invention may be an effective, non-intrusive and low cost solution for preventing kidnappings and for assisting parents to rapidly locate lost, wandering or abducted children. The system may also be adapted to locate lost, wandering or abducted adults or pets as well as locate any misplaced or stolen object.

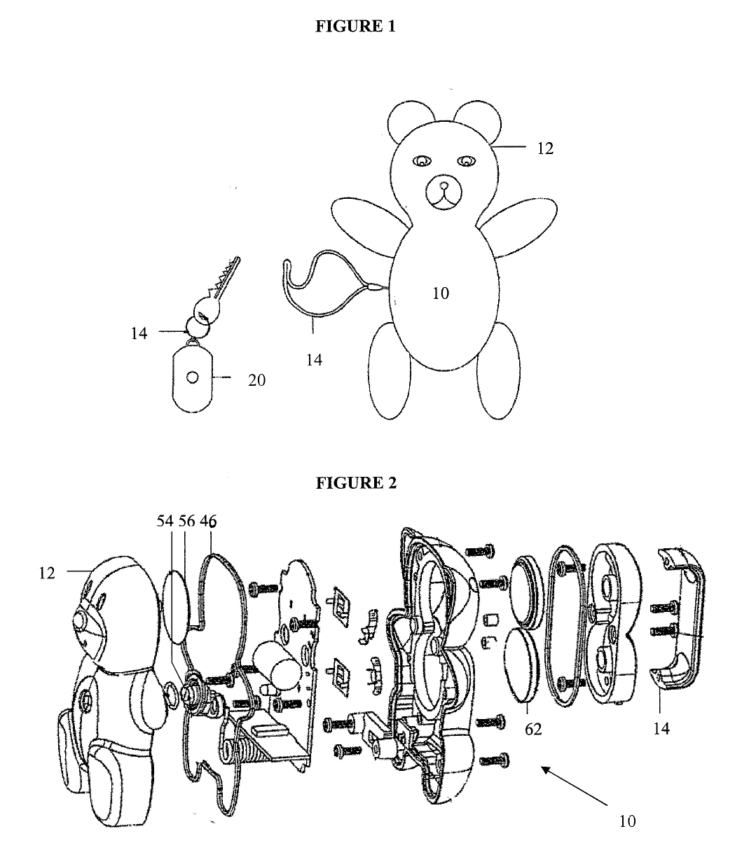

In an exemplary embodiment, a remote locator system 100 of the present invention may include at least two operational remote locator units. As shown in FIG. 1, a first unit 10 may be attached to, worn by or located in close proximity to a person, animal or object to be monitored, and a second unit 20 may be used to monitor the position or movement of the first unit 10. In another exemplary embodiment, a remote locator system 200 may include at least two remote locator units 10, 20 capable of monitoring and/or locating one another. The remote locator systems of the present invention may optionally include one or more additional units that are also capable of monitoring first unit 10 and/or being monitored by second unit 20. The remote locator system may also include a third unit capable of monitoring and/or tracking the other units within the system, including other monitoring units, such as second unit 20.

First unit 10 may be attached to, worn by, on or located in close proximity to a child to be monitored. The effective concealment of the first unit 10 on or in close proximity to a child is an objective of the present invention. To facilitate concealment, the first unit 10 may be sized so as to avoid detection. Preferably, the first unit 10 is a small device that can be easily hidden. In one embodiment, the largest dimension of first unit 10 may be less than about 4 inches, preferably, less than about 2.5 inches, more preferably, less than about 2 inches, and most preferably, less than about 1.5 inches. In an exemplary embodiment, first unit 10 may also be water resistant and remain operational when wet or submerged in a liquid.

In an exemplary embodiment, the first unit 10 may be incorporated in or attached to an article of clothing or an accessory worn by the child, such as part of a child's glasses, shoe, belt, belt buckle, button, hat, barrette, watch, watch strap, or bracelet. Preferably, as shown in FIGS. 1-2, the first unit 10 may have an inconspicuous ornamental housing 12 typical of a child's apparel that may be shaped like: an animal figure; a cartoon character; a vehicle, such as an automobile, boat, plane, train or bicycle; a food item; a representation of nature, such as a sun, a star, or a moon; a tree; or a toy, such as a ball or doll. Housing 12 may have a design that is inconspicuous to avoid detection and/or appealing to children.

First unit 10 may be attached to an article of clothing or accessory worn by a child using retaining means 14. Retaining means 14 may be any device capable of directly or indirectly securing first unit 10 proximate to a child so as to prevent the accidental removal, separation or loss of first unit 10. In an exemplary embodiment, retaining means 14 may include a chain, a zipper, fabric, buttons, clamps, snaps, clasps, lace or a combination thereof. As shown in FIG. 2, retaining means 14 may be a ring or bracket integral with the housing 12. In one embodiment, the ring or bracket that may be tied to a child's shoe with the child's shoe laces.

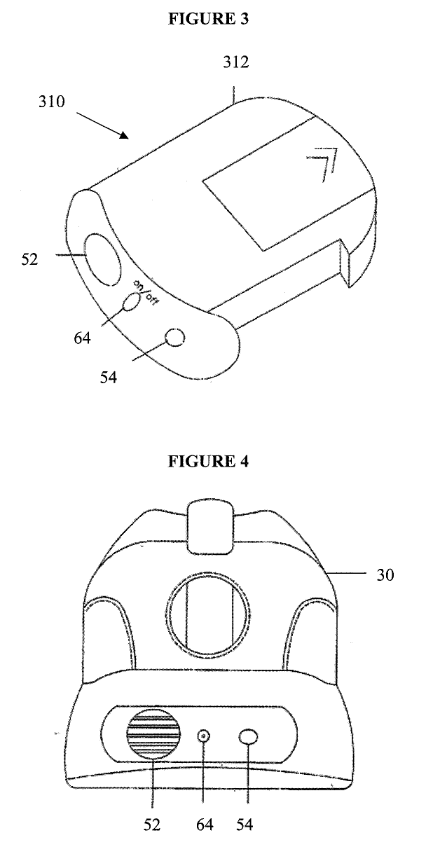

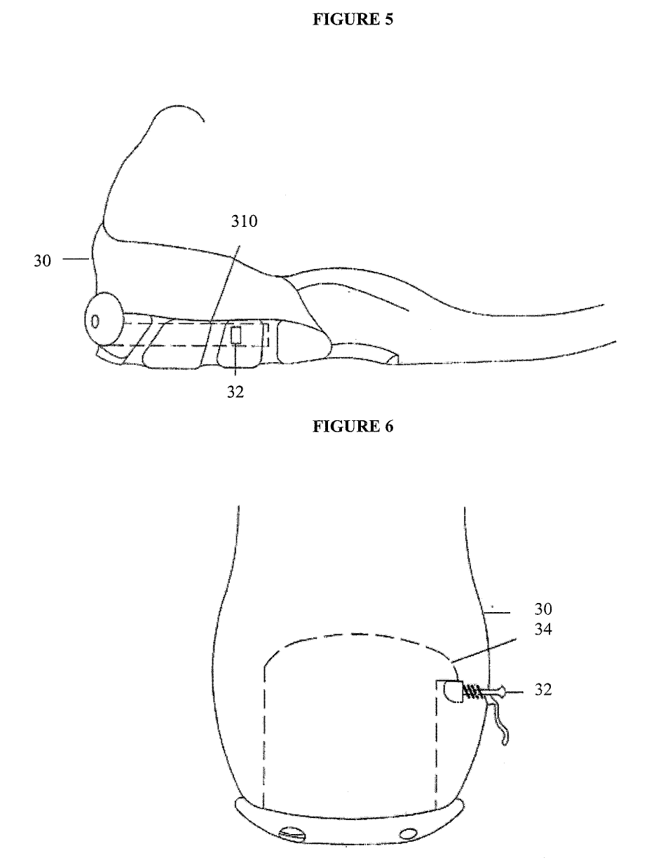

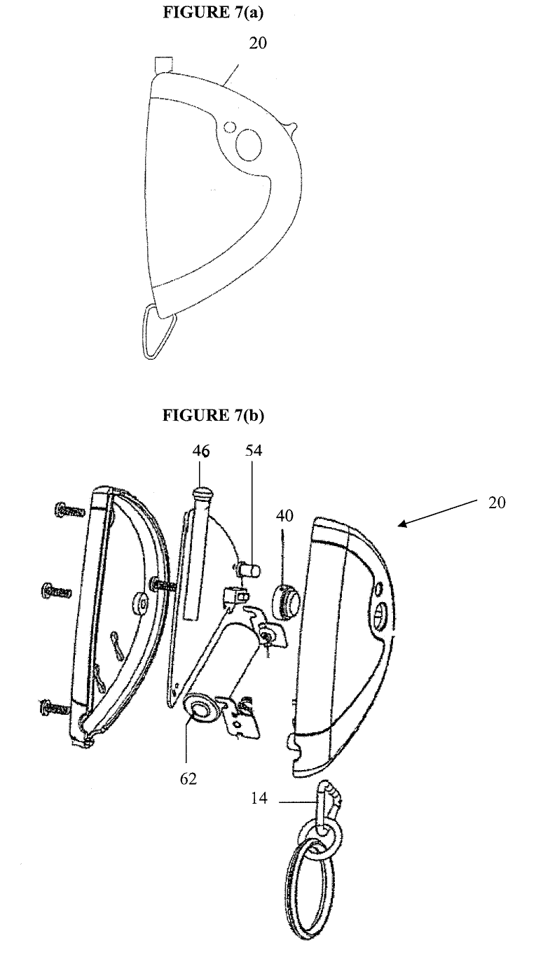

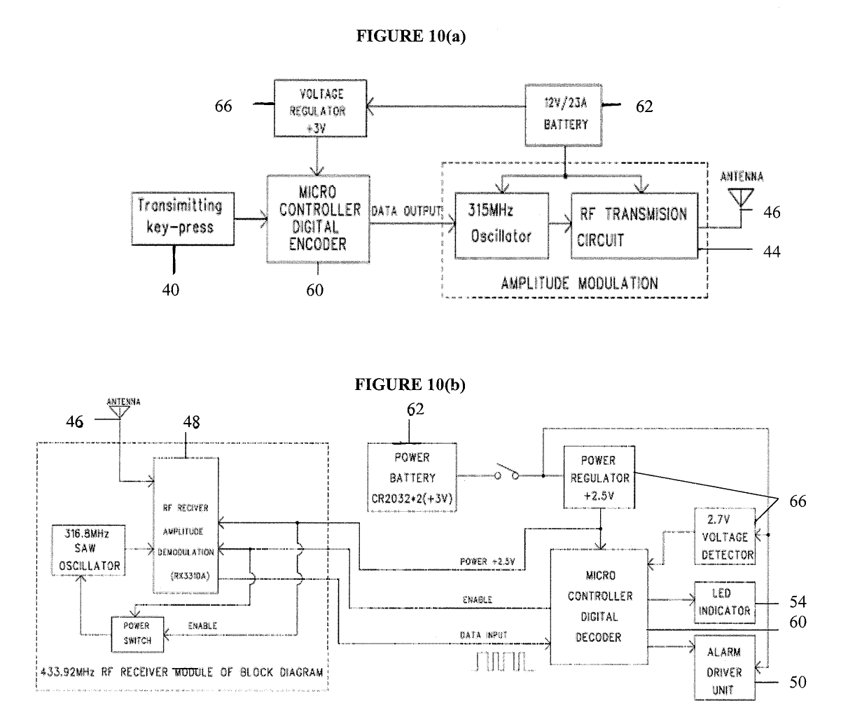

In another embodiment, first unit 10 may also be removably inserted in or integrally constructed as part of a clothing or an accessory item, preferably one of the aforementioned clothing and accessory items. For example, a first unit 310 may be located within the heel of a shoe or within the frame of a pair of glasses. In this embodiment, ornamental housing 312 may be at least partially visible or may be embedded so as to be entirely hidden from view. First unit 310 may be therefore effectively concealed to avoid detection by a child abductor. As shown in the exemplary embodiment of FIGS. 3-6, a first unit 310 may be inserted within the heel of a shoe 30. FIG. 10, shows a spring loaded release button 32 which latches with an end 34 of housing 312 to enable first unit 310 to be removably inserted and locked within shoe 30.

In another exemplary embodiment, first unit 10 may be attached to, removably inserted in, or integrally constructed as part of an object located in close proximity to a child. For example, the object may be a child transporter, such as a child carrying device, a carriage, a stroller; or a child's toy, such as a doll or trinket, i.e. stuffed animal, figurine, action figure or other toy. First unit 10 may be attached to the object using retaining means 14. Alternatively, first unit 10 may be embedded in the object such that it is either at least partially visible or entirely hidden from view.

As shown in FIGS. 7(a)-7(b), Remote locator system 100 further includes a second unit 20 which may function to monitor and/or locate first unit 10. Second unit 20 may be a small hand held ergonomic device. As shown in the embodiment of FIG. 1, it may be configured to have a size and shape conducive for attachment to a key chain. Alternatively, second unit 20 may be attached to an article of clothing or any object using any attachment device, including retaining means 14. Preferably, second unit 20 is water resistant. For example, second unit 20 may be constructed from injection molded plastic and suitable seals that enable operation when wet or submerged in a liquid. In an exemplary embodiment, second unit 20 may be about 2-3 inches in length by approximately 1 inch in width.

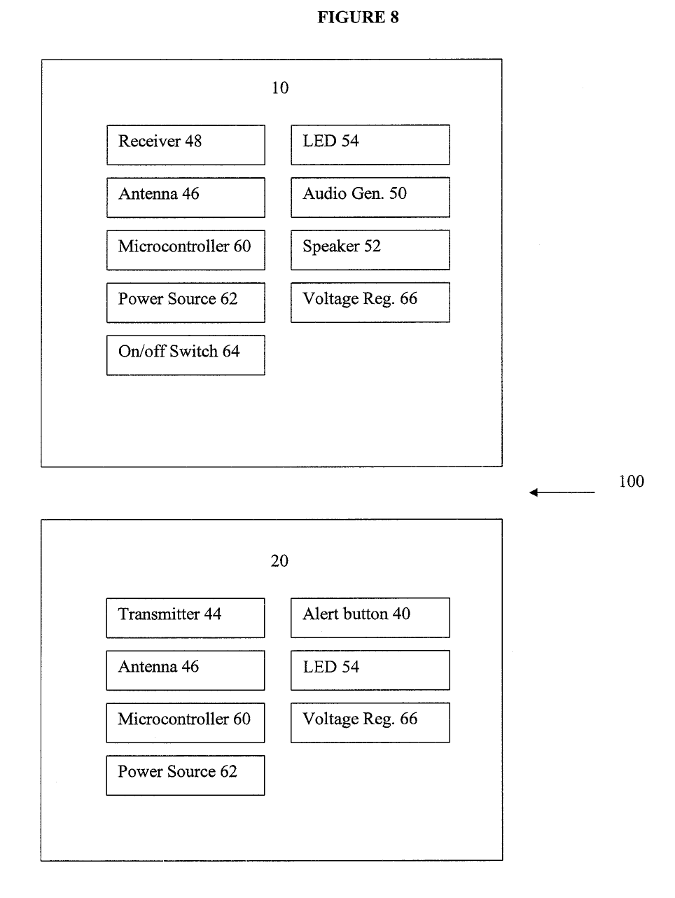

Now referring to FIGS. 8-10, First unit 10 and second unit 20 may be simple, effective, and user friendly devices with a variety of operational components. In an exemplary embodiment, first unit 10 and second unit 20 may each include one or more of: an alert button 40, a time delay module 42, a transmitter 44, an antenna 46, a receiver 48, an audio generator 50, a speaker 52, a light emitting diode (LED) 54, an electromechanical transducer 56, an identification module 58, a microcontroller or microprocessor 60, a power source 62, an on/off switch 64, a voltage regulator 66, a proximity device 68, a distance gauge 70, a distance indicator display 72, an anti-tampering device 74, or a combinations thereof. Notably, first unit 10 and second unit 20 may be designed so as to only consist of a limited selection of these operational components in order to produce a simple device that may be easily and intuitively operated in emergency situations. Additionally, first unit 10 and second unit 20 may have different operational components. FIGS. 8-10 show exemplary embodiments of the first unit 10 and second unit 20 including different combinations of the aforementioned operational components, the functions for which are described below.

A remote locator unit 10, 20 of the present invention may include an alert button or switch 40 electrically connected to a transmitter 44. When alert button 40 is depressed, the transmitter sends a signal to a receiver 48 in a corresponding remote locator unit 10, 20 to activate an alarm. The alert button 40 may be designed to prevent accidental activation. In one embodiment, alert button 40 may have a time delay activation feature. For example, a time delay module 42, which may be any conventional time delay circuit, accepts an input signal from alert button 40 and after a predetermined delay period passes the input signal to transmitter 44. Time delay module 42 may be set to any time delay interval; in an exemplary embodiment, the time delay interval may be about five seconds or less. Accidental activation may also be avoided by countersinking alert button 40 relative to the remote locator unit 10, 20.

Upon activating alert button 40, transmitter 44 emits a radio frequency signal to be received by corresponding receiver 48. Transmitter 44 may generate a signal at any suitable frequency on any designated bandwidth, preferably a high frequency on an approved FCC bandwidth. In an exemplary embodiment, the frequency may be within the range of about 1-1,500 MHz, preferably about 315-1,500 MHz, and the transmission bandwidth may be about 433 MHz. Transmitter 44 may be able to communicate with receiver 48 at these frequencies over long distances. In an exemplary embodiment, transmitter 44 may communicate with receiver 48 over a distance of about 0-200 ft, preferably, about 0-150 ft.

Radio frequency signals from transmitter 44 to receiver 48 may be transmitted and received using antenna 46. As shown in FIGS. 1-4, antenna 46 may be a loop type antenna embedded along the perimeter of the first unit 10 and/or an extension antenna located in the housing of second unit 20. Other antennas, such as microwave, dipole and multiple arrays, may also be used.

Upon depressing alert button 40, a signal is sent from transmitter 44 to receiver 48 to activate an alarm to produce an emergency alert. The emergency alert may be any indicator that would draw attention to and facilitate the location of a remote locator unit 10, 20. Preferably, the emergency alert may also draw the attention of individuals located proximate to the remote locator to signal an emergency situation. In an exemplary embodiment, the emergency alert may be an audible sound, a visual display or other indicator. Specifically, the emergency alert may be a loud, repeated and/or high pitched noise, such as a beep or horn, generated by audio generator 50 and speaker 52 and/or a light generated by LED 54 that illuminates, flashes and/or changes color. The signal may also induce a remote locator unit 10, 20 to vibrate by activating an electromechanical transducer 56 in order to notify the individual carrying the vibrating unit that he is being sought. In an exemplary embodiment, upon depressing alert button 40, the emergency alert may become louder, brighter, change colors or emit more frequent sounds, flashes or vibrations as first unit 10 and second unit 20 draw closer to one another. Additionally, an audio generator 50 and speaker 52, LED 54, or electromechanical transducer 56 of the corresponding remote locator unit may also emit sounds, lights and/or vibrations as first unit 10 and second unit 20 draw closer together.

The various components and the overall operation of the remote locator units 10, 20 may be controlled by a microcontroller or microprocessor 60. As shown in the exemplary circuit diagram of FIG. 10, microcontroller 60 may control the activation of transmitter 44, encrypt transmission signals between digital and analog, identify signals received from transmitter 44 and control alarm activation.

In one embodiment, microprocessor 60 may incorporate or may be operatively connected to an identification module 58, which functions to prevent errant signals from interfering with the operation of the remote locator system and to ensure secure transmissions. Identification module 58 may be a functionally integral feature of microprocessor 60 and/or the circuitry of remote locator units' 10, 20. Alternatively, microprocessor 60 may be a functionally integral feature of identification module 58. According to one embodiment, identification module 58 may generate and/or recognize a unique digital binary electronic signature that is unique to each remote locator system. This enables corresponding remote locator units 10, 20 of the same system to send and receive information with one another without signal interference.

Additionally or alternatively, identification module 58 may prevent signal interference by selecting a unique frequency on which the remote locator units 10, 20 communicate. In an exemplary embodiment, each time the remote locator units 10, 20 are turned on, identification module 58 may randomly select a unique frequency out of at least 1,500 possible communication channels after an initial activation of alert button 40. In one embodiment, the communication frequency may be within the range of about 1-1,500 MHz, preferably about 315-1,500 MHz. This step of selecting a communication frequency, i.e. arming the remote locator system, involves the process of pressing alert button 40 after the remote locator units 10, 20 are first turned on. The initial activation of alert button 40 induces identification module 58 and/or microprocessor 60 of second unit 20 to randomly select a communication channel and send a signal to first unit 10 to set the communication frequency. The selected communication frequency may be impressed on identification module 58 and/or microprocessor 60 of first unit 10. Second unit 20 and impressionable first unit 10 should be positioned within a few feet, preferably, less than about 10 feet, more preferably, less than about 5 feet, of one another in order to arm the remote locator unit. Alternatively, first unit 10 may select, establish and transmit a chosen communication frequency to an impressionable second unit 20. Upon arming the remote locator system, first unit 10 and/or second unit 20 may produce an audio, visual or other arming confirmation indicator to notify a user that a communication frequency has been established. For example, an audio generator 50 and speaker 52 may emit one or more sounds, such as a beep, an LED 54 may illuminate, flash and/or change color, and/or an electromechanical transducer 56 may vibrate.

In an exemplary embodiment, identification module 58 is an inherent feature of microprocessor 60 and microprocessor 60 controls the selection, impression and establishment of a unique transmission frequency to enable communication between receiver 48 and transmitter 44 without interference from other remote locator systems or other radio frequency signal sources and/or generate and/or recognizing a unique digital binary electronic signature that is unique to each remote locator system. Microprocessor 60 may also control other operational features of the remote locator units 10, 20.

The remote locator units 10, 20 of the present invention each contain their own power source 62. Power source 62 may include a battery, a photovoltaic device, or any portable power supply means. In an exemplary embodiment, the power source 62 may be a 12 volt micro battery or a 2030 wafer battery. Preferably, the power source 62 may be a rechargeable power source that may be coupled to or cradled in a charging device in order to reenergize power source 62.

The power source 62 may be connected to an on/off switch or button 64. In an exemplary embodiment, the on/off switch 64 of first unit 10 may be inconspicuous, obscured and/or difficult to locate in order to avoid detection. The on/off switch 64 of first unit 10 may also be operatively associated with an anti-tampering device 74 which prevents first unit 10 from being turned off without first providing a designated signal, code or key. In one embodiment, the signal may be transmitted by second unit 20. In another embodiment first unit 10 may include a key pad for entering a code or key hole for receiving a key. The key may be attached to and/or removably housed in a compartment of second unit 20.

Power source 62 may be connected to a voltage regulator 66 that monitors the available amount of energy to operate the remote locator unit 10, 20 stored in power source 62. When the measured voltage drops below a predetermined level, such as about 2.6 V, voltage regulator 66 sends an electrical signal to microcontroller 60 to activate an alarm to produce a low power warning. For example, the low power warning may be manifested by the illumination, flashing and/or color change of LED 54; a sound, such as a beep or chirp, generated by audio generator 50 and speaker 52; and/or the vibration of electromechanical transducer 56. In an exemplary embodiment, voltage regulator module 66 will provide a low power warning at least 24 hours in advance of complete power depletion.

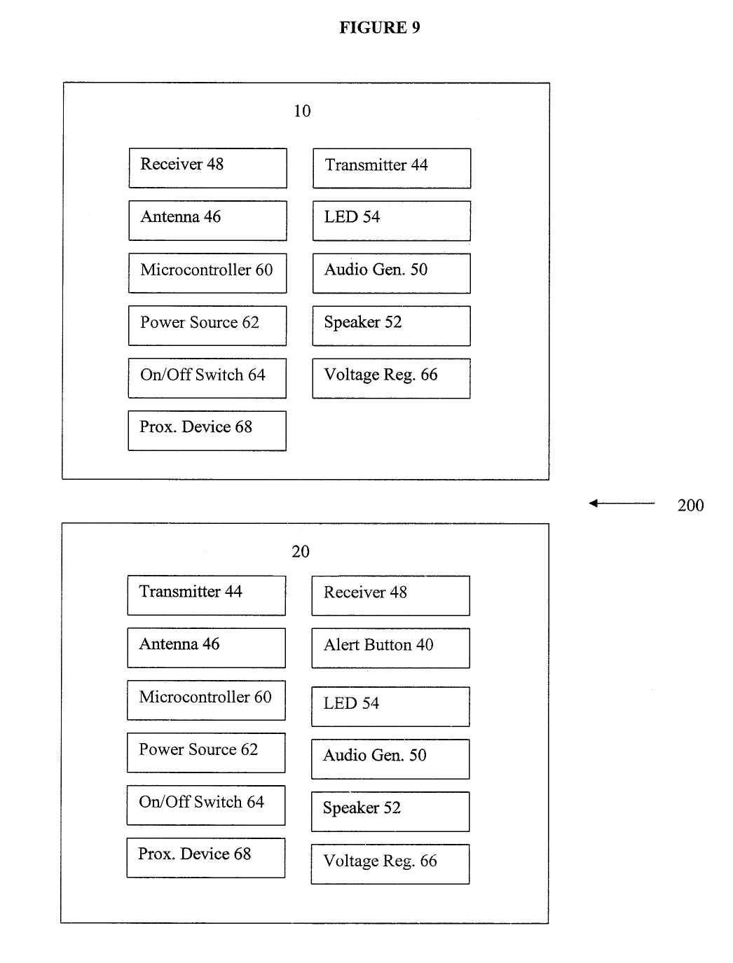

In an exemplary embodiment shown in FIG. 9, the remote locator unit 10, 20 may include a proximity device 68 that is capable of monitoring and/or measuring the distance between the first unit 10 and second unit 20. In one embodiment, a microcontroller 60 and transmitter 44 of one remote locator unit may be programmed to send a continuous and periodic stream of homing signals. The homing signals may be received by a receiver 48 of a corresponding remote locator which is electrically connected to proximity device 68 and microcontroller 60. By analyzing the signal strength and/or time intervals between the received homing signals, proximity device 68 and/or microcontroller 60 may monitor and/or measure the distance between the first unit 10 and second unit 20. In an exemplary embodiment, the first unit 10 and second unit 20 are both sending as well as receiving the homing signals. For example, proximity device 68 may be electrically connected to receiver 48 to detect a constant stream of periodic electronic homing signals from a remote locator unit 10, 20 and may also be electrically connected to a transmitter 44 to send periodic homing signals.

When the remote locator units 10, 20 are separated by such a large distance that they can no longer communicate with one another, proximity device 68 may direct microcontroller 60 to activate an alarm to produce a proximity breach warning and/or emergency alert. Alternatively, a proximity breach warning and/or emergency alert may be produced when proximity device 68 determines that the distance between two remote locator units 10, 20 have exceeded a preset distance. In an exemplary embodiment, the preset distance may be about 25 feet, 30 feet, 50 feet or 100 feet. Optionally, proximity device 68 may include a distance gauge 70 or other means for adjusting and setting the preset distance. In an exemplary embodiment, the proximity breach warning may be manifested by the illumination, flashing and/or color change of LED 54; a sound, such as a beep or chirp, generated by audio generator 50 and speaker 52; and/or the vibration of electromechanical transducer 56. The warning may prompt a user to press alert button 40, activating the alarm to produce an emergency alert. Alternatively, proximity device 68 may automatically activate an emergency alert.

Proximity device 68 may also enable second unit 20 to periodically monitor and track the location of first unit 10. In one embodiment, a distance indicator display 72 may be operatively connected to proximity device 68 to show the distance separating the first unit 10 and second unit 20. The proximity device 68 may determine the position of as well as relative direction and distance between of the first unit 10 and second unit 20. In an exemplary embodiment, the proximity device 68 may activate the alarm to produce a tracking indicator. For example, proximity device 68 may instruct microprocessor 60 to activate: audio generator 50 and speaker 52 to produces different, louder, softer, longer, shorter and/or more frequent sounds; LED 54 to change color, change visual displays, and/or increase flash frequently; and/or electromechanical transducer 56 to increase the frequency of vibration, as first unit 10 and second unit 20 draw closer together.

The remote locator system of the present invention may be programmed such that the tracking indicator, arming confirmation indicator, low power warning, proximity breach warning, emergency alert, and other alerts and indicators of the present system may be distinct from one another to avoid confusion. Each alert or indicator may have a unique sound, sound volume, sound duration, sound frequency, visual display, visual display frequency, vibration or combination thereof.

The present invention has been described with reference to the enclosed preferred embodiment. It is to be appreciated that the other embodiments may fulfill the spirit and scope of the present invention and that the true nature and scope of the invention must be determined with respect to the claims appended hereto.

What is claimed is:

1. A remote locator system comprising:
a first unit comprising:
a first receiver for receiving a signal from a first transmitter;
a first alarm for producing an alert;
a first microcontroller for enabling communication with a second unit on a select frequency, wherein said first microcontroller is operatively associated with said first receiver to receive a signal;
a first voltage regulator for indicating a low power supply; and
a first power supply;
wherein said first unit is removably attached to or integral with an article worn by or an object located proximal to an individual; and
a second unit comprising:
said first transmitter for transmitting a signal to said first receiver;
a button for activating said alarm;
a second microcontroller for randomly selecting said frequency to enable secure communication with said first unit, wherein said second microcontroller is operatively associated with said first transmitter to produce a signal;
a second alarm for producing an alert;
a second voltage regulator for indicating a low power supply; and
a second power supply.

2. The system of claim 1, wherein said first unit further comprises a first proximity device that receives a signal from said second unit to determine when the first unit has exceeded a predetermined distance from a second unit.

3. The system of claim 2, wherein the first unit further comprises a second transmitter; and wherein said second unit further comprises a second receiver and a second proximity device for receiving a signal from said first unit to indicate when the first unit has exceeded a predetermined distance from the second unit.

4. The system of claim 1, wherein said first unit is embedded within an object selected from the group consisting of: a child carrying device, a carriage, and a stroller.

5. The system of claim 1, wherein first unit is an article worn by an individual and has an ornamental housing shaped like an animal figure and wherein said second unit may be attached to a key chain.

6. The system of claim 1, wherein first unit is an article worn by an individual and wherein said article is selected from the group consisting of: glasses, shoe, belt, belt buckle, button, hat, barrette, watch, watch strap, and bracelet.

7. The system of claim 5, wherein either said first unit further includes an retaining means shaped like a ring or bracket, wherein said retaining means is integral with the housing of said first unit.

8. The system of claim 5, wherein either said first unit or said second unit is water resistant.

9. The system of claim 1, wherein either said first unit further includes an anti-tampering device operatively associated with the on-off switch.

10. The system of claim 7, wherein said anti-tampering device is a key hole and wherein a key corresponding to said key hole is attached to or said second unit.

11. A remote locator system comprising:
a first unit consisting essentially of:
a first receiver for receiving a signal from a first transmitter;
a second transmitter for sending a signal to a second receiver;
a first antenna;
an alarm for producing an alert;
a first microcontroller for enabling communication with a second unit on a select frequency;
a first proximity device that receives a signal from a second unit to determine when the first unit has exceeded a predetermined distance from a second unit;
a first voltage regulator for indicating a low power supply;
a first power supply; and
a first on/off switch,
wherein said first unit is removably attached to or integral with an article worn by or an object located proximal to an individual; and
a second unit consisting essentially of:
said first transmitter for transmitting a signal to said first receiver;
said second receiver for receiving a signal from said second transmitter;
a second antenna;
a second alarm for producing an alert;
a button for activating said audio generator;
a second microcontroller for randomly selecting said frequency to enable secure communication with said first unit;
a second proximity device that receives a signal from said first unit to indicate when the first unit has exceeded a predetermined distance from the second unit;
a second voltage regulator for indicating a low power supply;
a second power supply; and
a first on/off switch.

12. The system of claim 9, wherein first unit is integral with an object located proximal to an individual and wherein said object is selected from the group consisting of: a child carrying device, a carriage, and a stroller.

13. A method for using a remote locator system comprising the steps of:
providing a remote locator system comprising:
a first unit comprising:
a first receiver;
a first alarm;
a first microcontroller;
a first voltage regulator; and
a first power supply; and
a second unit comprising:
a first transmitter;
a button;
a second microcontroller;
a second alarm;
a second voltage regulator; and
a second power supply.
arming said remote locator units;
sending a signal from said transmitter of said second unit to said receiver of said first unit to activate said first alarm.

14. The method of claim 13, further comprising the step of monitoring a power level of said second power supply with said second voltage regulator and activating said second alarm when said second power supply falls below a predetermined power level.

15. The method of claim 13, wherein said arming step comprises: pushing said button; selecting and establishing a communication frequency; and wherein at least one of said first unit or said second unit generates an arming confirmation indicator.

16. The method of claim 15, wherein said communication frequency is randomly selected from at least 1,500 different frequencies.

17. The method of claim 13, wherein said first unit further comprises:
a second transmitter; and a
first proximity device; and
wherein said second unit further comprises:
a second receiver; and
a second proximity device; and
wherein said method further comprises the steps of:
monitoring a distance between said first and second units using said first unit and said second unit; and
activating said second alarm when said first unit exceeds a preset distance from said second unit.

18. The method of claim 13, wherein said step of sending said signal from said transmitter of said second unit to said receiver of said first unit further comprising the step of activating said second alarm, wherein said second alarm produces an alert, and wherein said alert changes as the first unit and second units are drawn closer together to facilitate location of either said first unit or said second unit.

19. The method of claim 18, wherein said alert is selected from the group consisting of: a sound, visual display or combination thereof, and wherein said change in the alert is selected from the group consisting of: a change in the frequency of the sound, a change in the volume of the sound, a change in the type of sound, a change in the duration of the sound, a change in the frequency of the visual display, a change in the color of the visual display, a change in the appearance of the visual display, a change in the duration of the visual display, or a combination thereof.

20. The method of claim 13, wherein said first unit includes a key hole, wherein a key corresponding to said key hole is attached to said second unit, and wherein said method further comprises inserting said key into said key hole in order to turn off said first unit.
